(19) United States
(12) Patent Application Publication
(10) Pub. No.: US 2003/0111329 A1
(43) Pub. Date: Jun. 19, 2003

(54) Overhead electric appliance combination control switch arrangement

(76) Inventor: Jung-Tsung Wei, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/015,743

(22) Filed: Dec. 17, 2001

(51) Int. Cl. H01H 3/20

(52) U.S. Cl. 200/331

(57) ABSTRACT

An overhead electric appliance combination control switch arrangement is constructed to include a mechanical switch connected to an overhead electric appliance, a pull line suspended from the mechanism switch and adapted for driving the mechanical switch to control the functioning of the overhead electric appliance when pulled by the user, and a photoelectric sensor connected to the pull line and adapted for controlling the functioning of the overhead electric appliance when the user touches the pull line with the hand or move the hand toward the photoelectric sensor.

### BACKGROUND OF THE INVENTION

1. Field of the Invention

The present invention relates to an overhead electric appliance control device and, more particularly, to an overhead electric appliance combination control switch arrangement, which uses a pull line with a mechanical switch and a photoelectric sensor for controlling the functioning of an overhead electric appliance.

2. Description of the Related Art

An overhead electric appliance, for example, a ceiling fan or ceiling lamp may be equipped with a control switch and a pull line suspended from the control switch for operation control. Through the pull line, the user can control the overhead electric appliance conveniently. However, it is complicated to control the functioning of the overhead electric appliance through the pull line. When operating the control line, it takes four steps (see FIGS. from 1 through 4) as follows:

1. extending the hand to the pull line (see FIG. 1);

2. seizing the pull line with the hand (see FIG. 2);

3. moving the hand to pull the pull line downwards (see FIG. 3); and

4. releasing the hand from the pull line (see FIG. 4).

The aforesaid procedure seems simple. However, things are not always what they seem. Before pulling the pull line, the user must accurately positively seize the pull line. Further, when pulling the pull line, the hand must be lowered vertically. If the user moves the hand obliquely downwards, the pull line may be unable to switch the controls witch accurately. Therefore, the pull line must be pulled in the accurate direction. Further, when pulling the pull line in a rush, the internal mechanism of the control switch tends to be damaged. On the contrary, insufficient pulling force cannot drive the pull line to switch the control switch. When the user's hand slipped from the pull line during a control operation, the pull line swings back and forth, and the user may have to take much time to seize the pull line again.

Further, various key-entry control devices as well as wireless control devices have been disclosed for use with electric appliances. However, these advanced electric appliance control devices are complicated. Most people cannot use these advanced electric appliance control devices without learning. It is difficult to some people, more particularly, the old persons to learn the functioning of an advanced key-entry control device or wireless control device.

### SUMMARY OF THE INVENTION

The present invention has been accomplished under the circumstances in view. It is one object of the present invention to provide an overhead electric appliance combination control switch arrangement, which enables the user to control the functioning of the electric appliance conveniently. It is another object of the present invention to provide an overhead electric appliance combination control switch arrangement, which is humanized to fit different users. To achieve these and other objects of the present invention, the overhead electric appliance combination control switch arrangement comprises a mechanical switch connected to an overhead electric appliance and adapted for controlling the functioning of the overhead electric appliance, a pull line suspended from the mechanism switch and adapted for driving the mechanical switch to control the functioning of the overhead electric appliance when pulled by the user, and a photoelectric sensor connected to the pull line and adapted for controlling the functioning of the overhead electric appliance when the user touches the pull line with the hand or move the hand toward the photoelectric sensor.

### BRIEF DESCRIPTION OF THE DRAWINGS

FIG. 1 illustrates the operation of a pull switch according to the prior art (Step I).

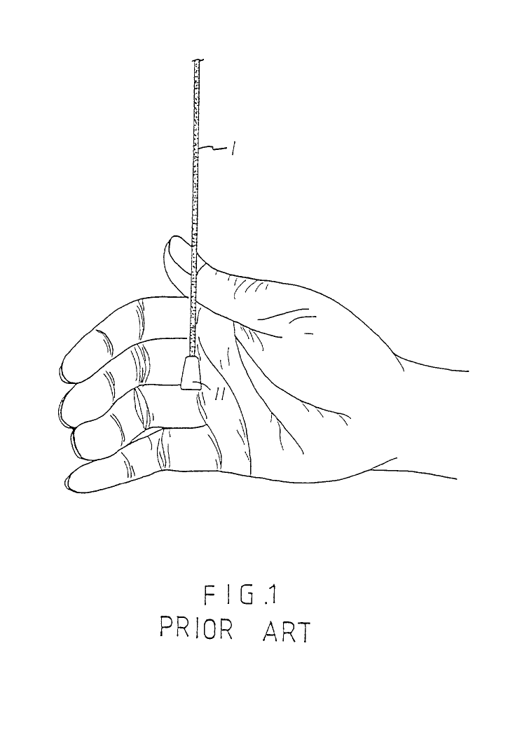

FIG. 2 illustrates the operation of a pull switch according to the prior art (Step II).

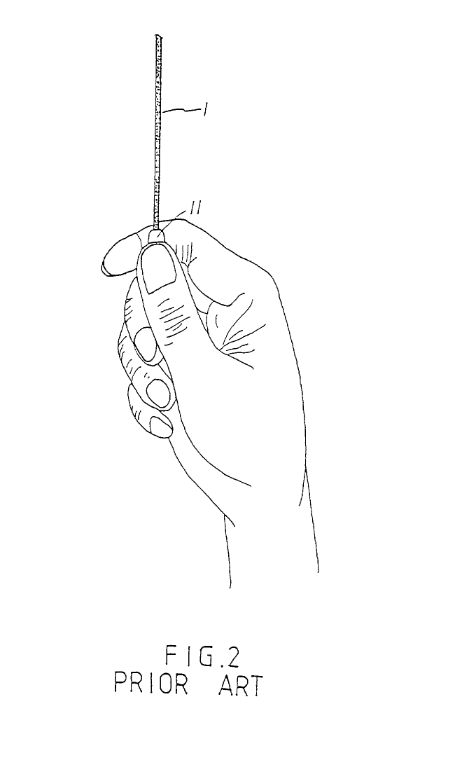

FIG. 3 illustrates the operation of a pull switch according to the prior art (Step II)

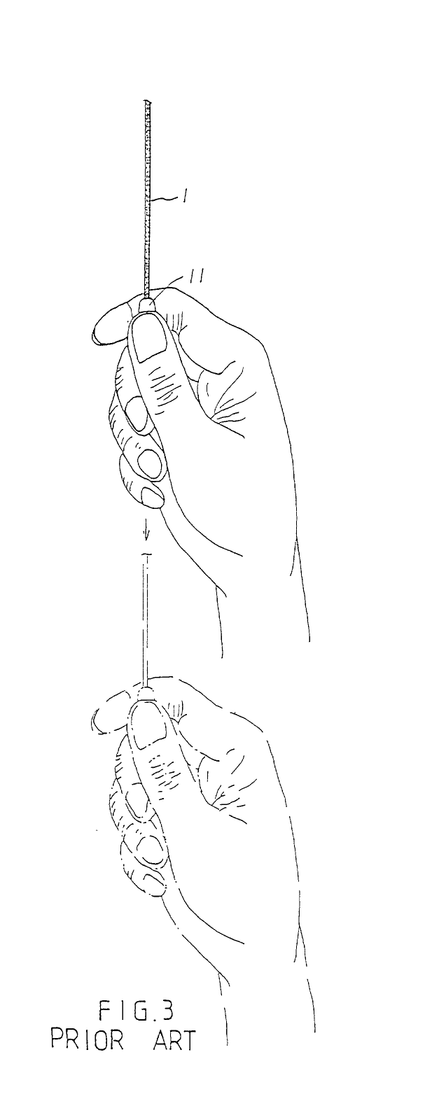

FIG. 4 illustrates the operation of a pull switch according to the prior art (Step IV).

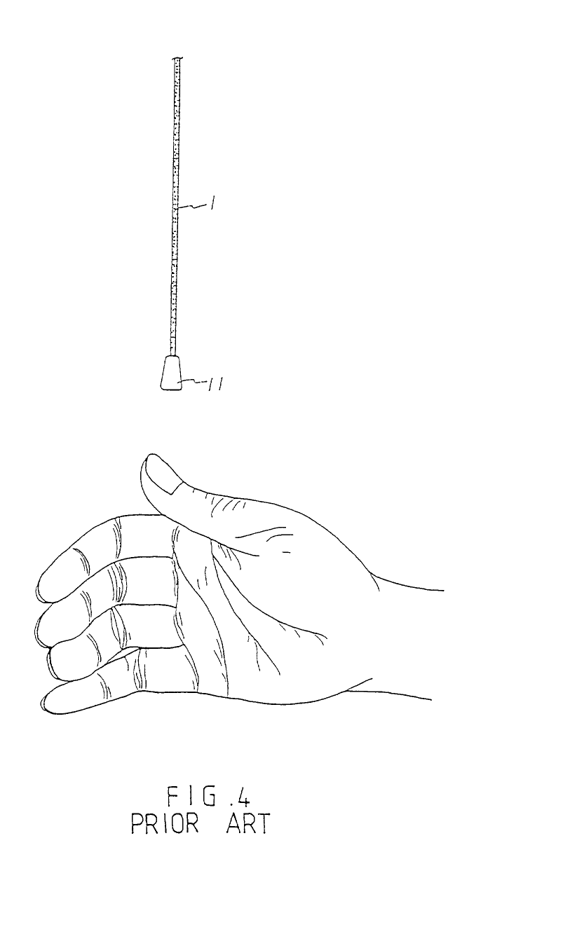

FIG. 5 illustrates an application example of an overhead electric appliance combination control switch arrangement.

### DETAILED DESCRIPTION OF THE PREFERRED EMBODIMENT

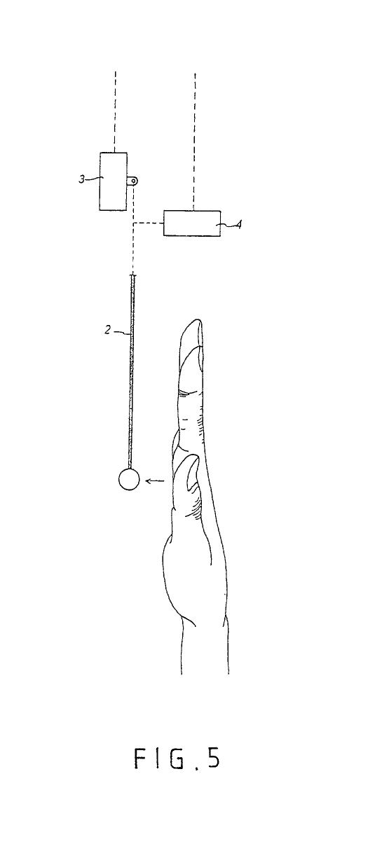

Referring to FIG. 5, an overhead electric appliance combination control switch arrangement in accordance with the present invention is shown comprised of a mechanical switch 3, a photoelectric sensor 4, and a pull line 2. The pull line 2 is a flexible wire, having one end connected to the mechanical switch 3. When the user pulled the pull line 2 downwards, the mechanical switch 3 is switched to control the functioning of the electric appliance connected to the mechanical switch 3. The photoelectric sensor 4 can be connected to or directly installed in the pull line 2 so that when the user's hand touching the pull line 2 or approaching the photoelectric sensor 4, the photoelectric sensor 4 is induced to achieve the desired switching function.

When the user touched the pull line 2 and moved the hand toward the pull line 2, the photoelectric sensor 4 is induced to input a control signal into a control device, causing the control device to switch on/off or regulate the electric appliance. The control signal produced by pulling the pull line 2 and the control signal produced by touching or approaching the pull line 2 with the hand work alternatively. For example, the user can pull the pull line 2, causing the mechanical switch 3 to turn on the electric appliance, and then the user can pull the pull line 2 again or move the hand toward the photoelectric sensor 4, causing the control device to turn off or regulate the electric appliance. Therefore, when the mechanical switch 3 (or the photoelectric sensor 4) fails to function well, the user can still use the photoelectric sensor 4 (or the mechanical switch 3) to control the operation of the electric appliance. The combination of the two control methods (the method through the mechanical switch and the method through the photoelectric sensor) fits different operational habits from different users, achieving a humanized design.

Further, the control effect of the pull line 2 to the electric appliance is determined subject to the number of touches or approaches. For example, the ceiling fan is switched to the low speed mode when the user touched or approached the pull line 2 with the hand at the first time, the ceiling fan is switched to the medium speed mode when the user touched or approached the pull line 2 with the hand at the second time within a limited length of time after the first touch or approach, the ceiling fan is switched to the high speed mode when the user touched or approached the pull line 2 with the hand at the third time within a limited length of time after the secondary touch or approach, . . . and so on.

A protocol of overhead electric appliance combination control switch arrangement has been constructed with the features of the annexed drawing of FIG. 5. The overhead electric appliance combination control switch arrangement functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An overhead electric appliance combination control switch arrangement comprising a mechanical switch connected to an overhead electric appliance and adapted for controlling the functioning of said overhead electric appliance, a pull line suspended from said mechanism switch and adapted for driving said mechanical switch to control the functioning of said overhead electric appliance when pulled by the user, and a photoelectric sensor connected to said pull line and adapted for controlling the functioning of said overhead electric appliance when the user touches said pull line with the hand or move the hand toward said photoelectric sensor.

2. The overhead electric appliance combination control switch arrangement as claimed in claim 1, wherein static electricity type, capacitive type, resistance type, electric current type, piezoelectric type, vibration type, thermal sensitive type, or magnetic type induction means may be used to substitute for said photoelectric sensor.

3. The overhead electric appliance combination control switch arrangement as claimed in claim 1 wherein said control line is formed of a rod member.
